(19) United States
(12) Patent Application Publication
(10) Pub. No.: US 2002/0197457 A1
(43) Pub. Date: Dec. 26, 2002

(54) Impregnated printed circuit board, and manufacturing method therefor

(75) Inventor: Jae Suk Eum, Kyunggi-do (KR)

Correspondence Address: Nathan N. Kallman, 20900 Sarahills Drive, Saratoga, CA, 95070, US

(73) Assignee: Global Circuit Co., Lts.

(21) Appl. No.: 10/173,073

(22) Filed: Jun. 17, 2002

(30) Foreign Application Priority Data
Jun. 21, 2001 (KR) 2001-35441

(51) Int. Cl. B32B 3/00

(52) U.S. Cl. 428/209; 216/75

(57) ABSTRACT

An impregnated printed circuit board and a manufacturing method for the same are disclosed, in which the surface for installing semiconductor devices is uniform. The manufacturing method includes the following steps. That is, a resist is spread on a metal sheet, and copper is coated on areas of the metal sheet other than the areas of the resist. The resist is removed, and another metal sheet is disposed in parallel to and slightly separated from the above metal sheet. Then an insulating resin is inserted into between the two metal sheets, and they are pressed together. Then the metal sheets are removed, thereby completing the manufacture of the impregnated printed circuit board. Thus the component-installing surface is smoothly flat, and any height difference between the circuit pattern and the base sheet is eliminated. Therefore, the formation of a short circuit or open circuit can be prevented. Further, the circuit pattern is buried into the insulating resin, and therefore, the printed circuit board can be made thinner as much as the thickness of the circuit pattern.

### FIELD OF THE INVENTION

The present invention relates to a printed circuit board and a manufacturing method for the same. Particularly, the present invention relates to an impregnated printed circuit board and a manufacturing method for the same, in which first a circuit pattern is formed on a metal sheet, and then, an insulating resin is coupled to the circuit pattern in such a manner that the surface for installing the semiconductor devices is uniform.

### BACKGROUND OF THE INVENTION

Generally, printed circuit boards are classified into: single layer printed circuit board, both-face printed circuit board, multi-layer printed circuit board and build circuit board in accordance with the forming methods. Or printed circuit boards are classified into: phenol printed circuit board and glass or epoxy printed circuit board in accordance with their base materials.

Such printed circuit boards are manufactured in the following manner as shown in FIG. 1. That is, as shown in FIG. 1a, a copper foil 2 which has a thickness of several microns is attached on a board 1 which is made of an epoxy resin. Then a resist 3 of a predetermined pattern is printed on it.

Then as shown in FIG. 1b, an etching is carried out to remove the unnecessary portions of the copper foil 2. Then as shown in FIG. 1c, the remaining resist 3 is removed by using a solvent or an alkaline solution, thereby forming a printed wiring board (PWB). Thereafter, nickel and gold are coated on the circuit pattern of the copper foil.

Meanwhile, generally semiconductor packages are classified into insertion mounting type (IMT) and surface mounting type (SMT) in accordance with the installation methods. Recently the electronic components are more and more miniaturized, and therefore, in order to improve the installability, the surface mounting type semiconductor packages are widely preferred over the insertion mounting type semiconductor packages.

The examples of the surface mounting type semiconductor packages include: QFP (Quad Flat Package), PLCC (Plastic Leaded Chip Carrier), CLCC (Ceramic Leaded Chip Carrier), BGA (Ball Grid Array) (which has a connecting solder ball on the bottom of the package), and CSP (Chip Scale Package) (in which the lead is exposed on the bottom of the package).

In the case where a plurality of connecting points are provided like in the BGA and CSP, if the surface of the printed circuit board is not uniform, or if a bending or a deflection occurs in the printed circuit board, then defects such as short circuit or open circuit are frequently generated compared with other components.

However, in the conventional printed circuit boards, first the base board is formed by using an insulating resin, and then, a resist is spread to remove the unnecessary portions of the copper foil. Accordingly a height difference is formed between the copper foil-remaining region and the copper foil-removed region.

Thus there is the problem that a short circuit or an open circuit occurs in the BGA or CSP in which a plurality of connecting points are provided. Further, even if a short circuit or an open circuit is not formed, the contact area between the solder balls and the copper foil is reduced, with the result that the contact reliability is aggravated.

### SUMMARY OF THE INVENTION

The present invention is intended to overcome the above described disadvantages of the conventional technique.

Therefore it is an object of the present invention to provide an impregnated printed circuit board and a manufacturing method for the same, in which a circuit pattern is formed on a metal sheet, and then, an insulating resin is coupled to the circuit pattern in such a manner that the surface for installing the semiconductor devices is uniform, and that a short circuit or an open circuit is prevented in the multiple-contact-point BGA or CSP, thereby improving the contact reliability.

In achieving the above object, one preferred embodiment of the impregnated printed circuit board according to the present invention is characterized in that: a predetermined circuit pattern is formed on a face of a metal sheet; another metal sheet is disposed in parallel to the above metal sheet; an insulating resin is inserted into between the two metal sheets; they are pressed together; and the two metal sheets are removed so as to make the circuit pattern buried into the insulating resin sheet.

Another preferred embodiment of the impregnated printed circuit board according to the present invention is characterized in that: two metal sheets are disposed in parallel to each other; a predetermined circuit pattern is formed on each of inside faces of the two metal sheets; an insulating resin is inserted into between the two metal sheets; they are pressed together; and the two metal sheets are removed so as to make the circuit patterns buried into both faces of the insulating resin sheet.

Still another preferred embodiment of the impregnated printed circuit board according to the present invention is characterized in that: a coating layer is formed on one face of a film; a predetermined circuit pattern is formed on the coating layer; another film is disposed in parallel to the above film; an insulating resin is inserted into between the two films; they are pressed together; and the films and the coating layer are removed so as to make the circuit pattern buried into the insulating resin sheet.

Still another preferred embodiment of the impregnated printed circuit board according to the present invention is characterized in that: a coating layer is formed on a metal sheet; a predetermined circuit pattern is formed on the coating layer; another metal sheet is disposed in parallel to the above metal sheet; an insulating resin is inserted into between the two metal sheets; they are pressed together; and the metal sheets and the coating layer are removed so as to make the circuit pattern buried into the insulating resin sheet.

In another aspect of the present invention, the method for manufacturing an impregnated printed circuit board in one preferred embodiment of the present invention includes the steps of: spreading a resist on a metal sheet, for forming a circuit pattern (first step); forming the circuit pattern by coating copper on areas other than areas of the resist (second step); removing the resist (third step); disposing another metal sheet slightly separated from and in parallel to the above metal sheet, inserting an insulating resin into between the two metal sheets, and pressing them together (fourth step); and removing the two metal sheets (fifth step).

The method for manufacturing an impregnated printed circuit board in another embodiment of the present invention includes the steps of: forming a copper foil layer on a metal sheet (first step); spreading a resist on the copper foil layer, for forming a predetermined circuit pattern (second step); removing the resist and the copper foil layer on the resist to form the circuit pattern on remaining portions of the copper foil layer (third step); disposing another metal sheet slightly separated from and in parallel to the above metal sheet, inserting an insulating resin into between the two metal sheets, and pressing them together (fourth step); and removing the two metal sheets (fifth step).

In still another preferred embodiment, the method for manufacturing an impregnated printed circuit board according to the present invention includes the steps of: disposing two metal sheets in parallel to each other, and spreading a resist on mutually facing faces of the two metal sheets, for forming predetermined circuit patterns (first step); coating copper on areas of the two metal sheets other than areas of the resist (second step); removing the resist (third step); inserting an insulating resin into between the two metal sheets, and pressing them together (fourth step); and removing the two metal sheets (fifth step).

In still another preferred embodiment, the method for manufacturing an impregnated printed circuit board according to the present invention includes the steps of: forming a nickel or copper coating layer on a film (first step); spreading a resist on the coating layer, for forming a predetermined circuit pattern (second step); forming the circuit pattern by coating copper on areas of the coating layer other than areas of the resist (third step); removing the resist (fourth step); disposing another film slightly separated from and in parallel to the above film, inserting an insulating resin into between the two films, and pressing them together (fifth step); and removing the two films and the coating layer (sixth step).

In still another preferred embodiment, the method for manufacturing an impregnated printed circuit board according to the present invention includes the steps of: forming a nickel or copper coating layer on a metal sheet (first step); spreading a resist on the coating layer, for forming a predetermined circuit pattern (second step); forming the circuit pattern by coating copper on areas of the coating layer other than areas of the resist (third step); removing the resist (fourth step); disposing another metal sheet slightly separated from and in parallel to the above metal sheet, inserting an insulating resin into between the two metal sheets, and pressing them together (fifth step); removing the two metal sheets and removing the coating layer (sixth step).

### BRIEF DESCRIPTION OF THE DRAWINGS

The above object and other advantages of the present invention will become more apparent by describing in detail the preferred embodiments of the present invention with reference to the attached drawings in which:

FIGS. 1a to 1c illustrate the manufacturing process for the general printed circuit board;

FIGS. 2a to 2f illustrate the manufacturing process for a preferred embodiment of the impregnated printed circuit board according to the present invention;

FIGS. 3a to 3e illustrate the manufacturing process for another preferred embodiment of the impregnated printed circuit board according to the present invention;

FIGS. 4a to 4f illustrate the manufacturing process for still another preferred embodiment of the impregnated printed circuit board according to the present invention;

FIGS. 5a to 5f illustrate the manufacturing process for still another preferred embodiment of the impregnated printed circuit board according to the present invention; and

FIGS. 6a to 6f illustrate the manufacturing process for still another preferred embodiment of the impregnated printed circuit board according to the present invention.

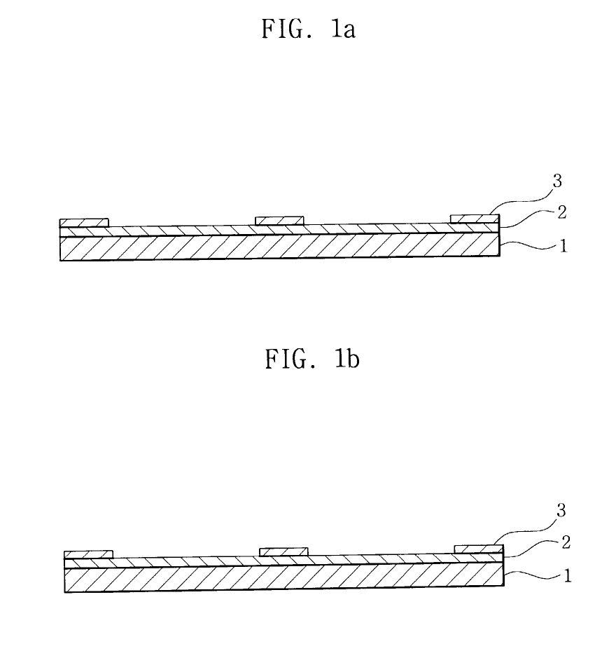

### DETAILED DESCRIPTION OF THE PREFERRED EMBODIMENTS

Now the present invention will be described in detail referring to the attached drawings.

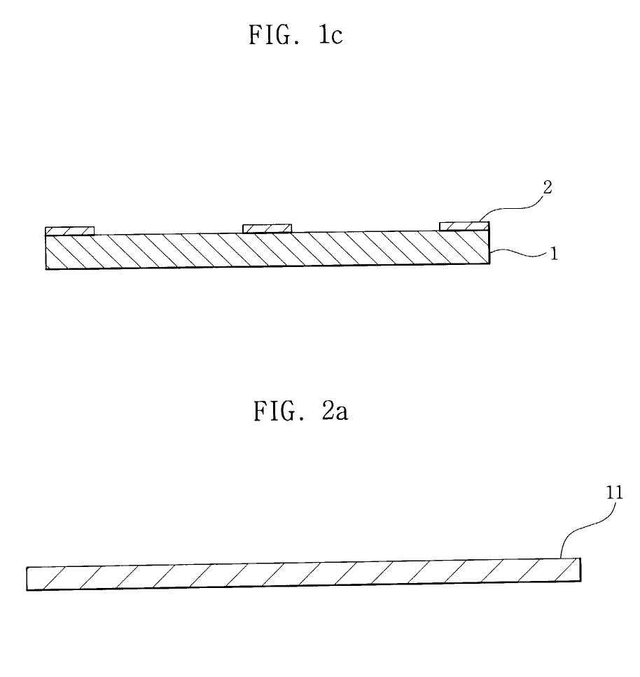

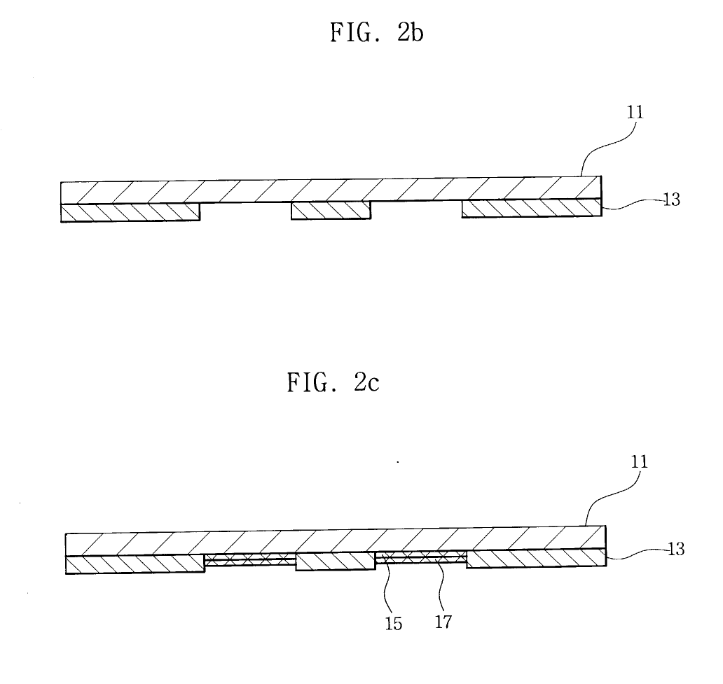

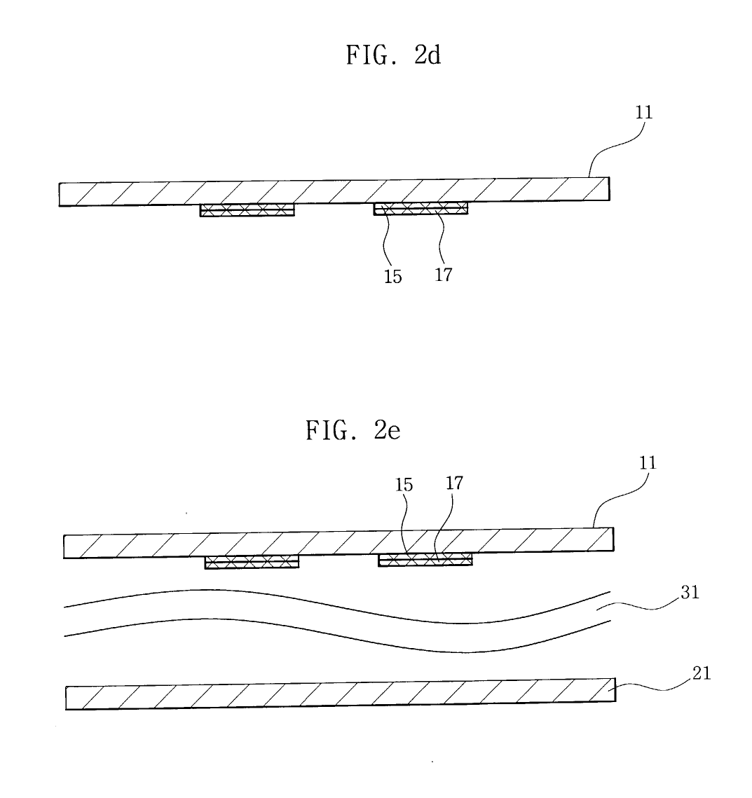

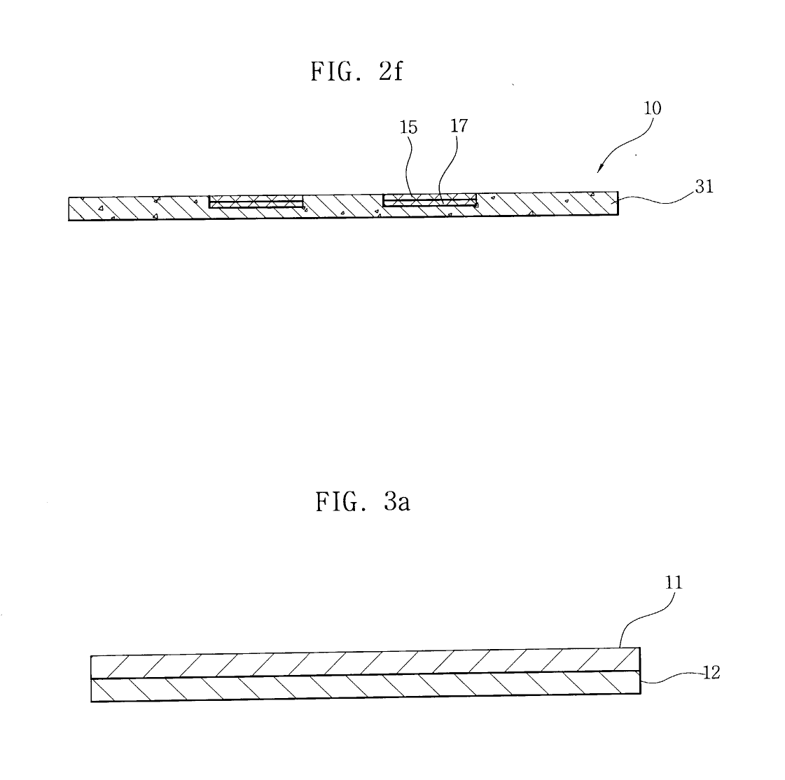

FIG. 2 illustrates the manufacturing process for a preferred embodiment of the impregnated printed circuit board according to the present invention.

First, as shown in FIG. 2a, a metal sheet 11 is prepared, and then, as shown in FIG. 2b, a resist 13 is spread on one face of the metal sheet 11, for forming a predetermined circuit pattern.

The resist 13 should be preferably the photo resist which is sensitive to the visible light. The metal sheet 11 should be preferably made of aluminum (Al). The reason why aluminum should be used is that aluminum is well dissolved in chemicals, is cheap in the price, and can be easily made into a flat sheet.

Then as shown in FIG. 2c, nickel is electroplated on the areas of the metal sheet 11 other than the resist regions to form a nickel layer 15. Then copper (Cu) is coated on the nickel layer 15 to form a circuit pattern which consists of a copper layer 17.

Under this condition, the copper layer 17 has a thickness of several scores of microns.

Meanwhile, generally a gold coating which is to be described later is carried out on the copper layer 17. Under this condition, if the gold coating is directly carried out on the copper layer 17, then copper and gold directly contact to each other to form an alloy layer, and therefore, the nickel layer 15 is provided.

Then when the circuit pattern consisting of the copper layer 17 is formed, the resist 13 is removed with a wash liquid such as a solvent or an alkaline solution.

Thus as shown in FIG. 2d, only the circuit pattern which consists of the nickel layer 15 and the copper layer 17 remains on the metal sheet 11.

Then another metal sheet 21 is disposed in parallel to the metal sheet 11 and separated by a certain distance from it, that is, separated as much as the thickness of the printed circuit board 10.

Then as shown in FIG. 2e, an insulating resin 31 consisting of a prepreg such as epoxy resin is inserted into between the two metal sheets 11 and 21, and then, they are pressed together.

Thus if the insulating resin 31 is inserted into between the two metal sheets 11 and 21, the insulating resin 31 is inserted up to the region where the resist 13 has been removed. Thus the insulating resin contacts to the two metal sheets 11 and 21, and therefore, the nickel layer 15 and the insulating resin 31 are positioned on the same plane.

Then as shown in FIG. 2f, when the insulating resin is cured, the two metal sheets 11 and 21 are removed by dissolving them with a chemical.

Then a gold coating is carried out on the circuit pattern region together with the formations of additional layers such as solder mask, thereby completing the printed circuit board 10. Here, the contact between the bonding wire and the solder ball is improved owing to the gold coating.

In this printed circuit board 10, the circuit pattern which has been formed through the spreading of the resist 13 and through the copper plating is buried into the insulating resin 31. Accordingly, the installing resin surface is uniform, and therefore, even in the case of the BGA and CSP having a plurality of connection points, any short circuit or open circuit can be prevented.

Meanwhile, the metal sheets 11 and 21 may be made of a stainless steel rather than aluminum. In this case, the printed circuit board is formed through the manufacturing process same as the above described one. However, in the above described process, the metal sheets 11 and 21 are removed by dissolving them in a chemical, but in the case of the stainless steel, the metal sheets are removed by a mechanical detachment because stainless steel is highly corrosion-resistant.

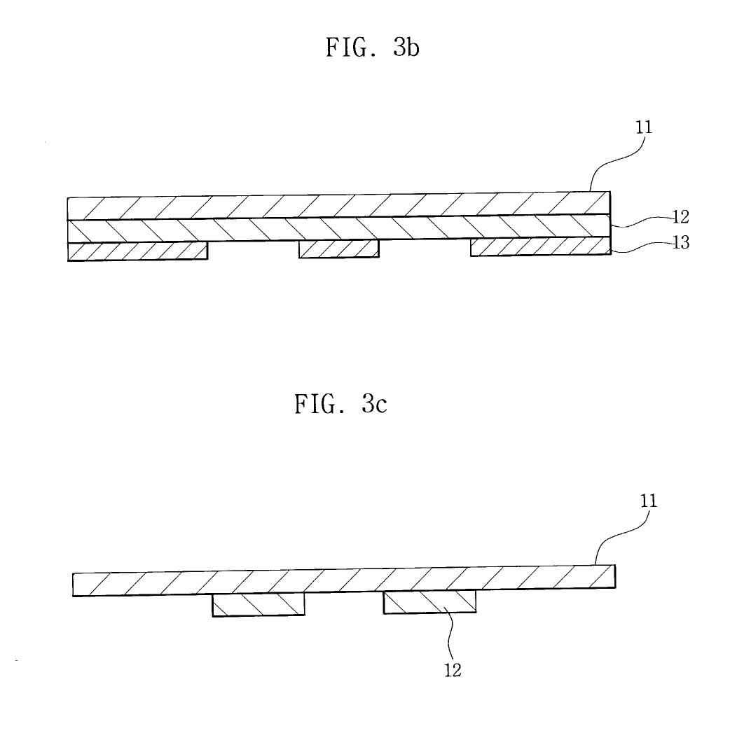

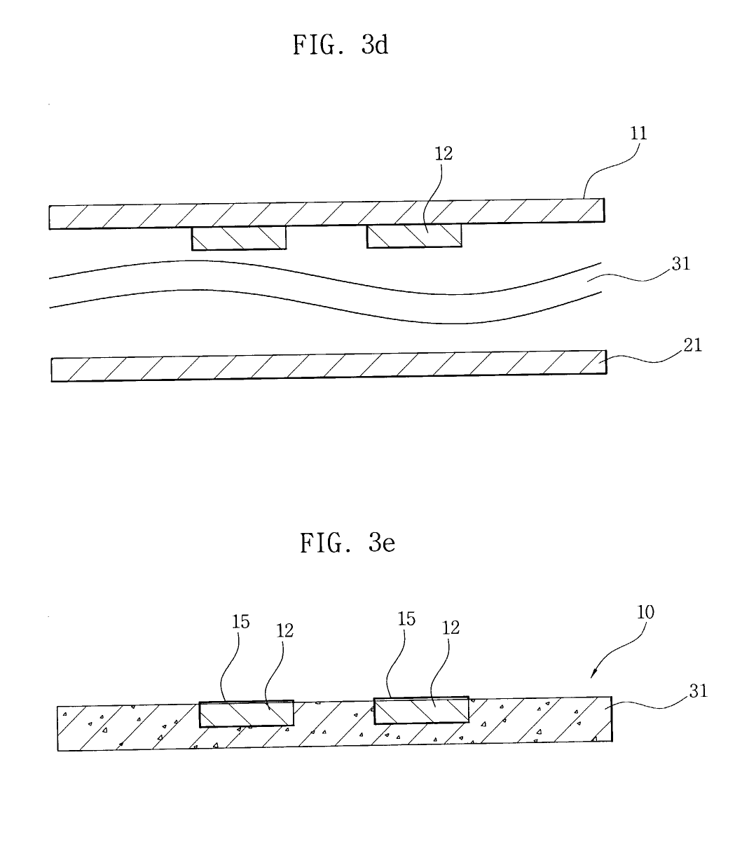

FIG. 3 illustrates the manufacturing process for another preferred embodiment of the impregnated printed circuit board according to the present invention. In the above described first embodiment, the nickel layer 15 and the copper layer 17 are buried in the printed circuit board 10, but in this embodiment, only a copper foil layer 12 is buried in the printed circuit board 10.

First as shown in FIG. 3a, either a copper sheet is attached onto a metal sheet 11 made of aluminum so as to form a copper foil layer 12, or copper is coated on the metal sheet 11 so as to form a copper foil layer 12 on the metal sheet 11.

Then as shown in FIG. 3b, a resist 13 is spread on the copper foil layer 12, for forming a predetermined circuit pattern. Then an etching is carried out to remove the resist 13 and the copper foil of the resist region, so that only the portions of the copper foil layer 12 on the circuit pattern-forming region remain as shown in FIG. 3c.

Then as shown in FIG. 3d like in the first embodiment, another metal sheet 21 is disposed separated from the metal sheet 11 at a certain distance, that is, separated from the metal sheet 11 as much as the thickness of the printed circuit board 10.

Then a prepreg type insulating resin 31 is inserted into between the two metal sheets 11 and 21, and they are pressed together.

When the insulating resin 31 is cured (solidified), the two metal sheets 11 and 21 are removed by dissolving them with a chemical. Then nickel is electroplated on the circuit pattern region of the printed circuit board 10 so as to form a nickel layer 15, and then, a gold coating is carried out.

Meanwhile, in this embodiment like in the first embodiment, stainless steel can be used for the metal sheets 11 and 21, and in this case, the two metal sheets 11 and 21 are removed by a mechanical detachment.

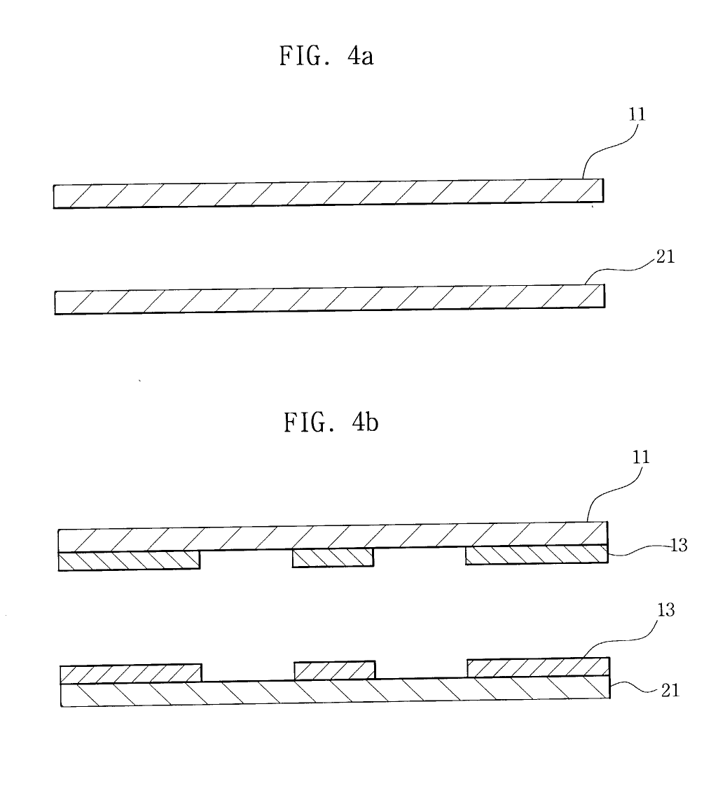

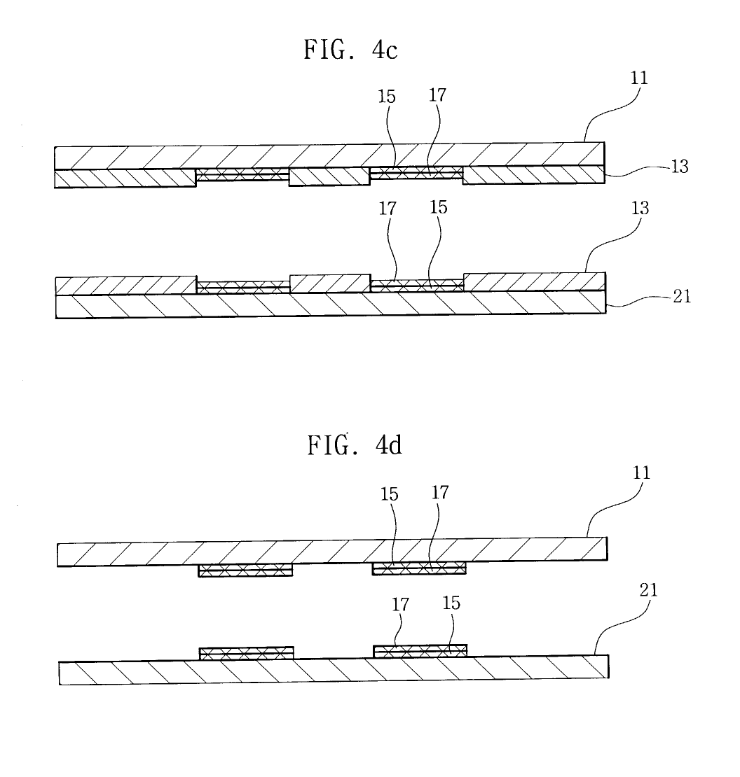

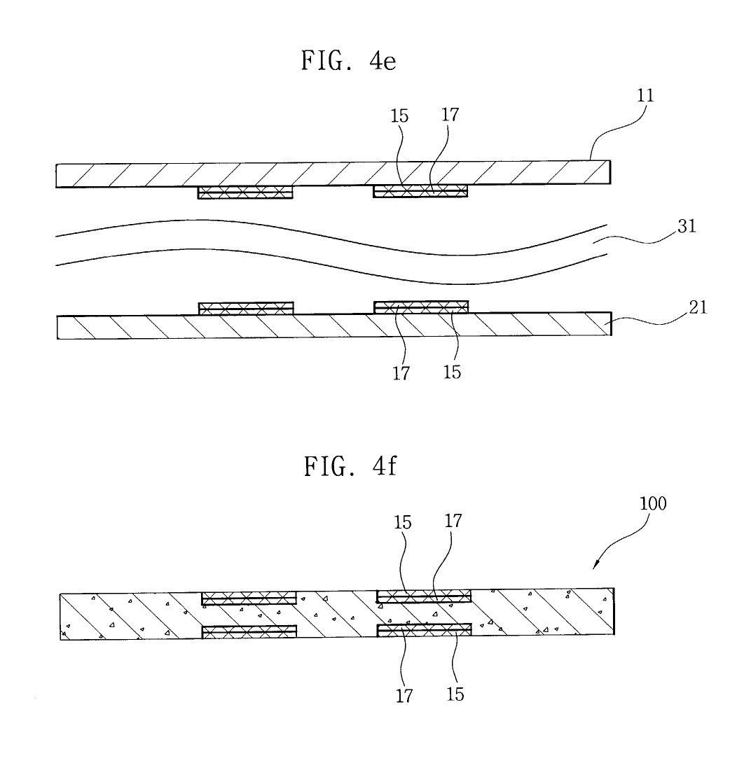

Meanwhile, even in the case where a multi-layer board (MLB) is formed, the above process can be applied. The formation of both-face printed circuit board will be described referring to FIG. 4.

First as shown in FIGS. 4a and 4b, two metal sheets 11 and 21 are disposed in parallel to each other, and resist 13 is spread on the mutually facing faces of the two metal sheets 11 and 21, for forming two sets of predetermined circuit patterns.

Here, the resist 13 should be preferably photo resist, and the metal sheets 11 and 21 are made of aluminum.

Then as shown in FIG. 4c, nickel is electroplated on areas other than the areas of the resist 13 so as to form a nickel layer 15, and then, copper is coated on the nickel layer 15, thereby forming a circuit pattern consisting of a copper layer 17.

After the formation of the copper layer 17, the resist 13 is removed by using a wash liquid such as a solvent or an alkaline solution.

Thus only the circuit pattern which consists of the nickel layer 15 and the copper layer 17 remains on each of the metal sheets 11 and 21.

Then as shown in FIG. 4e, an insulating resin 31 is inserted into between the two metal sheets 11 and 21, and they are pressed together. When the insulating resin is cured, the two metal sheets are removed by dissolving them with a chemical.

Then a gold coating is carried out on the circuit pattern region of the both-face printed circuit board 100 together with the formations of additional layers such as solder mask, thereby completing the printed circuit board 100.

That is, the two sets of the circuit patterns which have been formed by spreading the resist 13 and by coating copper are buried into the both faces of the insulating resin 31 respectively.

Now still another preferred embodiment will be described in which the materials of the metal sheets 11 and 21 are varied.

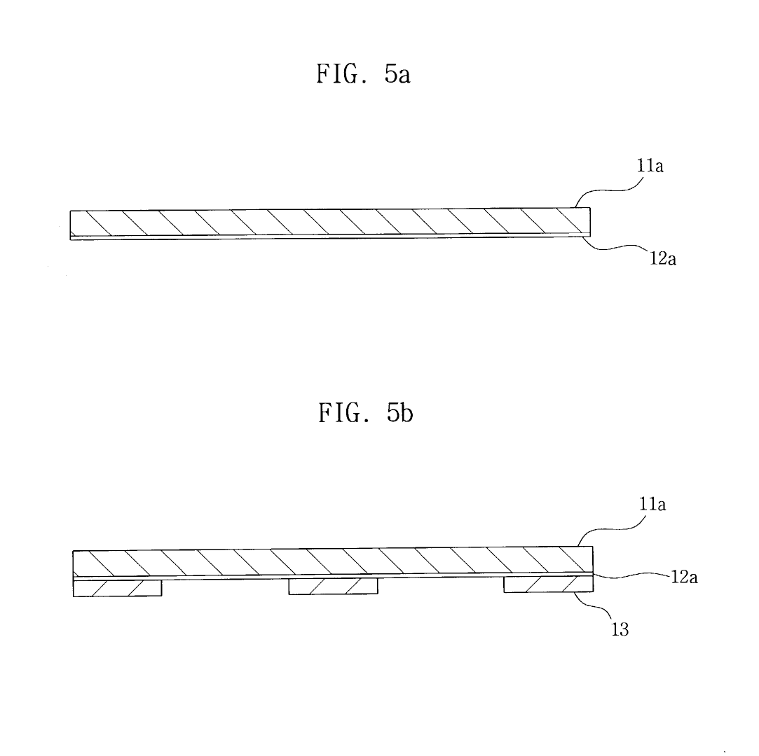

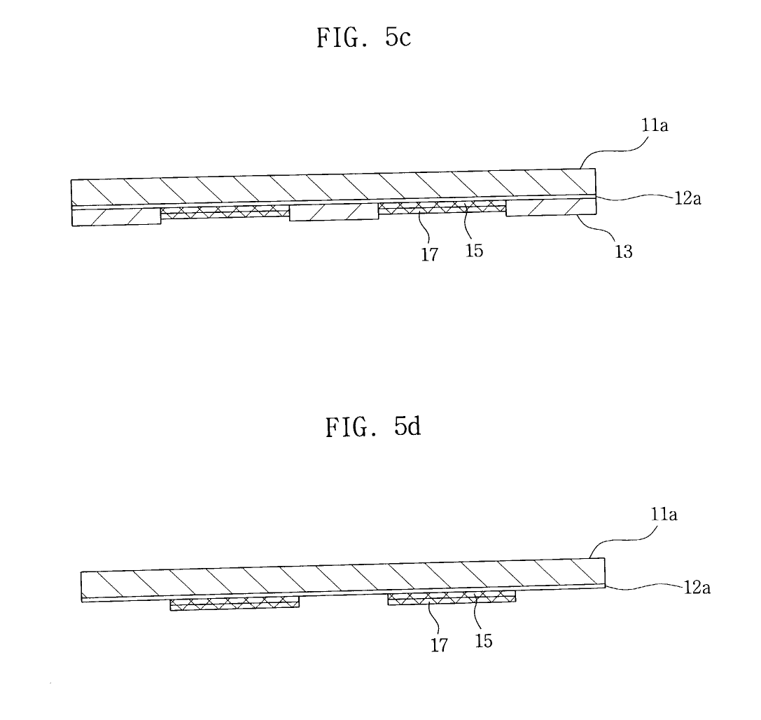

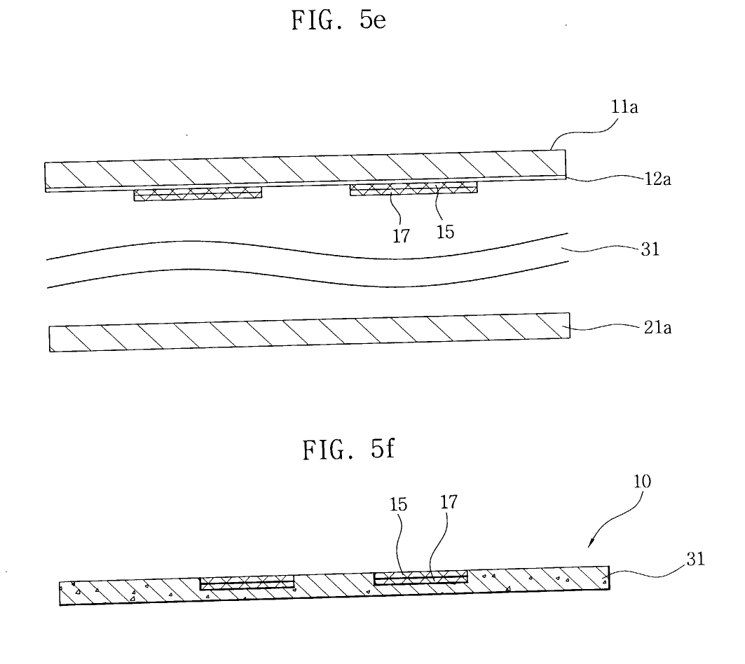

First as shown in FIG. 5a, a film 11a such as PE (Polyethylene) is prepared, and then, a nickel or copper coating layer 12a is formed on one face of the film 11a by applying a sputtering process.

Then as shown in FIG. 5b, a resist 13 is spread on the coating layer 12a, for forming a predetermined circuit pattern.

Then as shown in FIG. 5c, nickel is electroplated on areas of the coating layer 12a other than the areas of the resist 13 so as to form a nickel layer 15. Then copper is coated on the nickel layer 15 so as to form a circuit pattern consisting of a copper layer 17.

When the circuit pattern is formed in the form of the copper layer 17, the resist 13 is removed by using a wash liquid such as a solvent or an alkaline solution.

Thus as shown in FIG. 5d, only the circuit pattern which consists of the nickel layer 15 and the copper layer 17 remains on the coating layer 12a.

Then like in the first embodiment, another film 21a is disposed in parallel to and separated from the film 11a as much as a certain distance.

Then as shown in FIG. 5e, a prepreg type insulating resin 31 such as epoxy resin is inserted into between the two films 11a and 21a, and they are pressed together.

Thus if the insulating resin 31 is inserted into between the two films 11a and 21a, the insulating resin 31 reaches even the regions where the resist 13 has been removed. Thus the insulating resin 31 contacts with the films 11a and 21a, with the result that the nickel layer 15 and the insulating resin 31 are positioned on the same plane.

Then as shown in FIG. 5f, when the insulating resin 31 is cured, the two films 11a and 21a are removed by a mechanical method, and then, the coating layer 12a is removed by using a chemical.

Then a gold coating is carried out on the circuit pattern region together with the formations of additional layers such as solder mask and the like, thereby completing the printed circuit board 10.

In this printed circuit board 10 like FIG. 2f of the above embodiment, the circuit pattern which has been formed by spreading the resist 13 and by coating the copper is buried into the insulating resin 31.

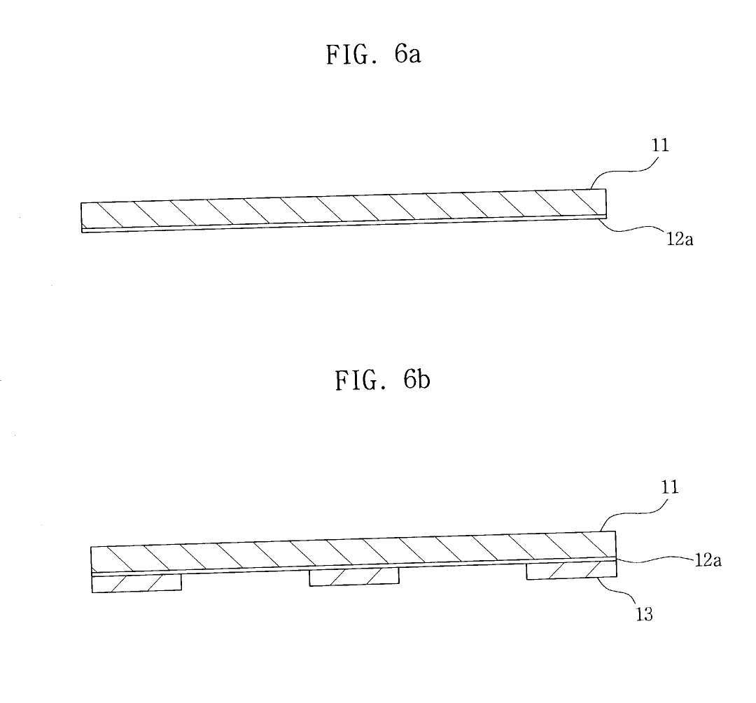

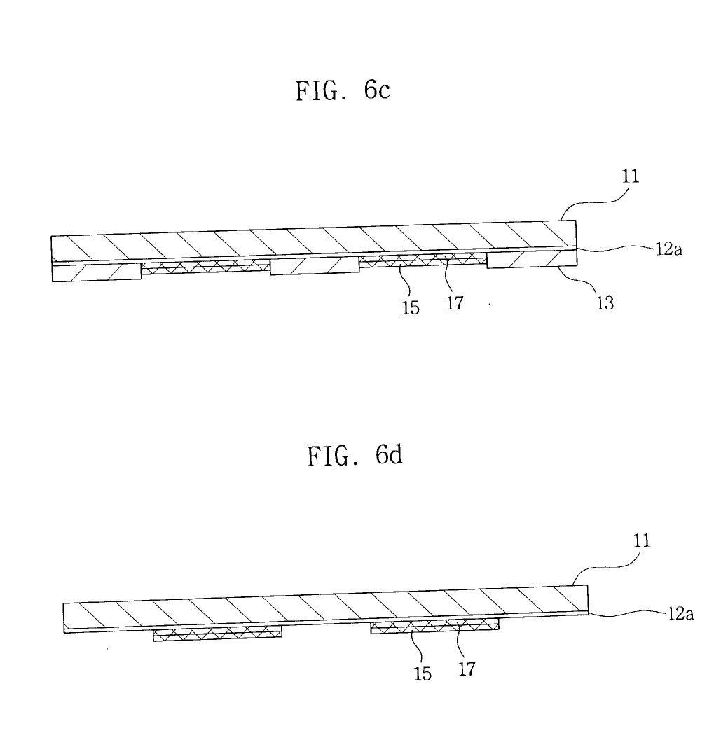

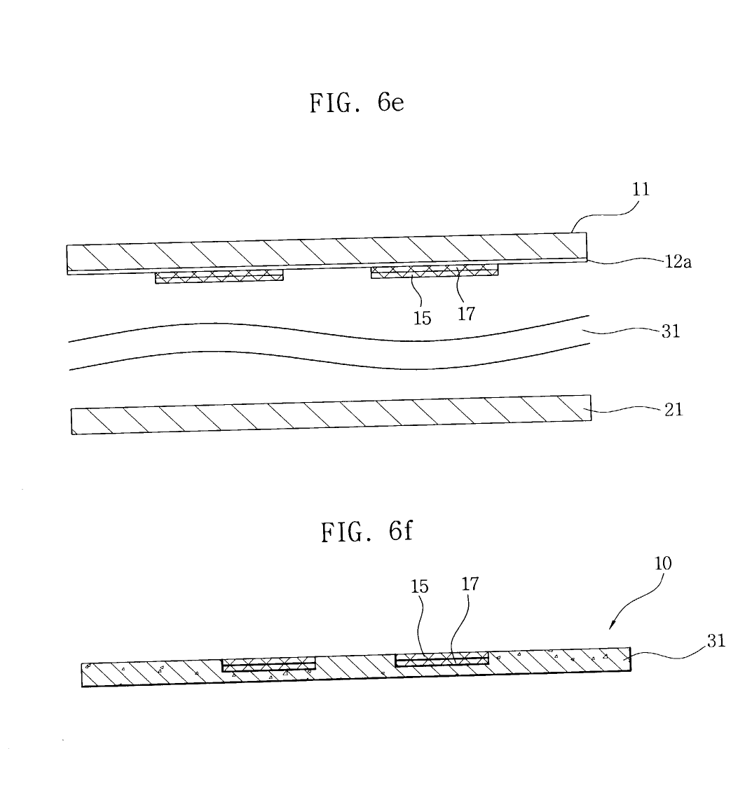

FIG. 6 illustrates still another embodiment of the present invention.

First as shown in FIG. 6a, a metal sheet 11 made of aluminum or the like is prepared, and then, a nickel or copper coating layer 12a is formed on one face of the metal sheet 11 by applying a sputtering process.

Then process steps same as FIGS. 5b to 5d are carried out, so that only a circuit pattern consisting of a nickel layer 15 and a copper layer 17 remains (FIGS. 6b to 6d).

Under this condition, like in the first embodiment, another metal sheet 21 is disposed in parallel to and separated from the metal sheet 11 as much as a certain distance. Then as shown in FIG. 6e, an insulating resin 31 is inserted into between the two metal sheets 11 and 21, and they are pressed together.

Thus when the insulating resin 31 is inserted into between the two metal sheets 11 and 21, the insulating resin 31 reaches the region where the resist 13 has been removed. Thus the insulating resin 31 contacts to the two metal sheets 11 and 21, and therefore, the nickel layer 15 and the insulating resin 31 are positioned on the same plane.

Then as shown in FIG. 6f, when the insulating resin 31 is cured, a thermal pressing is carried out. Then the two metal sheets 11 and 21 are removed by a mechanical method, and then, the coating layer 12a is removed with a chemical.

Then like in the above embodiments, a gold coating is carried out on the circuit pattern region together with the formations of additional layers such as solder mask, thereby completing the printed circuit board 10.

In the above, the present invention was described based on the specific preferred embodiments and the attached drawings, but it should be apparent to those ordinarily skilled in the art that various changes and modifications can be added without departing from the spirit and scope of the present invention, which will be defined in the appended claims.

According to the present invention as described above, a circuit pattern is formed on a metal sheet, another metal sheet is disposed, an insulating resin is inserted into between the two metal sheets, they are pressed together, and the two metal sheets are removed. Thus a printed circuit board can be manufactured in which the component-installing surface is uniformly flat.

Accordingly, in the case of BGA or CSP having a plurality of contact points, there can be prevented the formation of short circuit or open circuit which occurs due to the irregularity of the installing surface of the printed circuit board. Further, the contact area between the solder ball and the copper foil layer becomes uniform, and therefore, the contact reliability can be improved.

Further, the circuit pattern is buried into the insulating resin, and therefore, the overall thickness of the printed circuit board can be reduced as much as the thickness of the circuit pattern, as well as lowering the installation height of the components.

What is claimed is:

1. An impregnated printed circuit board characterized in that: a predetermined circuit pattern is formed on a face of a metal sheet; another metal sheet is disposed in parallel to the above metal sheet; an insulating resin is inserted into between the two metal sheets; they are pressed together; and the two metal sheets are removed so as to make the circuit pattern buried into the insulating resin sheet.

2. An impregnated printed circuit board characterized in that: two metal sheets are disposed in parallel to each other; a predetermined circuit pattern is formed on each of inside faces of the two metal sheets; an insulating resin is inserted into between the two metal sheets; they are pressed together; and the two metal sheets are removed so as to make the circuit patterns buried into both faces of the insulating resin sheet.

3. An impregnated printed circuit board characterized in that: a coating layer is formed on one face of a film; a predetermined circuit pattern is formed on the coating layer; another film is disposed in parallel to the above film; an insulating resin is inserted into between the two films; they are pressed together; and the films and the coating layer are removed so as to make the circuit pattern buried into the insulating resin sheet.

4. An impregnated printed circuit board characterized in that: a coating layer is formed on a metal sheet; a predetermined circuit pattern is formed on the coating layer; another metal sheet is disposed in parallel to the above metal sheet; an insulating resin is inserted into between the two metal sheets; they are pressed together; and the metal sheets and the coating layer are removed so as to make the circuit pattern buried into the insulating resin sheet.

5. A method for manufacturing an impregnated printed circuit board, comprising the steps of:
spreading a resist on a metal sheet, for forming a predetermined circuit pattern (first step);
forming the predetermined circuit pattern by coating copper on areas other than areas of the resist (second step);
removing the resist (third step);
disposing another metal sheet slightly separated from and in parallel to the above metal sheet, inserting an insulating resin into between the two metal sheets, and pressing them together (fourth step); and
removing the two metal sheets (fifth step).

6. The method as claimed in claim 5, further comprising the step of electroplating nickel on areas of the metal sheet other than a region of the resist prior to coating the copper at the second step.

7. The method as claimed in claim 5, wherein the metal sheets are removed by dissolving them with a chemical.

8. The method as claimed in claim 5, wherein the metal sheets are stainless steel sheets.

9. The method as claimed in claim 8, wherein the stainless steel sheets are removed mechanically.

10. A method for manufacturing an impregnated printed circuit board, comprising the steps of:
forming a copper foil layer on a metal sheet (first step);
spreading a resist on the copper foil layer, for forming a predetermined circuit pattern (second step);
removing the resist and the copper foil layer on the resist to form the circuit pattern on remaining portions of the copper foil layer (third step);
disposing another metal sheet slightly separated from and in parallel to the above metal sheet, inserting an insulating resin into between the two metal sheets, and pressing them together (fourth step); and
removing the two metal sheets (fifth step).

11. The method as claimed in claim 10, further comprising the step of forming a nickel layer on the copper foil layer after the fifth step.

12. The method as claimed in claim 10, wherein the metal sheets are removed by dissolving them with a chemical.

13. The method as claimed in claim 10, wherein the metal sheets are stainless steel sheets.

14. The method as claimed in claim 13, wherein the stainless steel sheets are removed mechanically.

15. A method for manufacturing an impregnated printed circuit board, comprising the steps of:
disposing two metal sheets in parallel to each other, and spreading a resist on mutually facing faces of the two metal sheets, for forming predetermined circuit patterns (first step);
coating copper on areas of the two metal sheets other than areas of the resist (second step);
removing the resist (third step);
inserting an insulating resin into between the two metal sheets, and pressing them together (fourth step); and
removing the two metal sheets (fifth step).

16. The method as claimed in claim 15, further comprising the step of electroplating nickel on areas of the metal sheets other than regions of the resist of the metal sheets prior to coating the copper at the second step.

17. A method for manufacturing an impregnated printed circuit board, comprising the steps of:
forming a nickel or copper coating layer on a film (first step);
spreading a resist on the coating layer, for forming a predetermined circuit pattern (second step);
forming the circuit pattern by coating copper on areas of the coating layer other than areas of the resist (third step);
removing the resist (fourth step);
disposing another film slightly separated from and in parallel to the above film, inserting an insulating resin into between the two films, and pressing them together (fifth step); and
removing the two films and the coating layer (sixth step).

18. The method as claimed in claim 17, further comprising the step of electroplating nickel on areas of the coating layer other than regions of the resist prior to coating the copper at the third step.

19. A method for manufacturing an impregnated printed circuit board, comprising the steps of:
forming a nickel or copper coating layer on a metal sheet (first step);
spreading a resist on the coating layer, for forming a predetermined circuit pattern (second step);
forming the circuit pattern by coating copper on areas of the coating layer other than areas of the resist (third step);
removing the resist (fourth step);
disposing another metal sheet slightly separated from and in parallel to the above metal sheet, inserting an insulating resin into between the two metal sheets, and pressing them together (fifth step); and
removing the two metal sheets and removing the coating layer (sixth step).

20. The method as claimed in claim 19, further comprising the step of electroplating nickel on areas of the coating layer other than regions of the resist prior to coating the copper at the third step.

21. The method as claimed in claim 19, wherein the metal sheets are subjected to a thermal pressing, and are detached mechanically.
